(19) United States
(12) Patent Application Publication
(10) Pub. No.: US 2010/0205564 A1
(43) Pub. Date: Aug. 12, 2010

(54) PORTABLE TELEPHONE AND A METHOD OF OPERATING IT

(76) Inventor: Søren Borup Jensen, Struer (DK)

Correspondence Address: HARNESS, DICKEY & PIERCE, P.L.C., P.O. BOX 8910, RESTON, VA, 20195, US

(21) Appl. No.: 12/733,539

(22) PCT Filed: Sep. 11, 2008
(86) PCT No.: PCT/EP2008/062070

§ 371 Date: Mar. 5, 2010

Related U.S. Application Data
(60) Provisional application No. 60/960,077, filed on Sep. 14, 2007.

(51) Int. Cl. G06F 3/048

(52) U.S. Cl. 715/830

(57) ABSTRACT

A system and a method of operating a portable telephone (10), wherein, such as when the telephone is idle, a user provides a movement along a closed curve, and the telephone in response directly provides information relating to contacts stored therein.

The present invention relates to a portable telephone and in particular to a manner of operating it.

Standard portable telephones have a number of operating modes, such as those of making a call, playing games, listening to music, operating a calendar, operating a position determining software (GPS), or the like. This increased number of different functionalities increases the demands to the input means and the structure of the software and operations thereof.

Another development in portable telephones is the increased use of phone books or contacts lists therein and the reduced use of the dialing function where a phone number is entered from the start-one cipher at the time.

Thus, the present invention relates to a manner of facilitating swift calling of a person from the contacts list.

In a first aspect, the invention relates to a method of operating a portable telephone, the method comprising:
receiving and/or identifying, using a receiving/identifying element, a movement of a user or an element along a closed curve,
receiving or providing, into a memory, information relating to one or more contacts,
upon receipt/identification of the movement, providing on a display/monitor information relating to one or more of the contacts.

In this context, a portable telephone may be a standard cell phone or mobile telephone or a telephone for shorter range use, such as DECT phones for use in office buildings or at home. Naturally, the portable telephone may be able to perform a number of other actions than those required to make a telephone call, such as act as a calendar, a GPS, a console for playing games, a console for surfing the WWW, a camera, a console for receiving/sending e-mails, SMS, MMS, or the like.

In the present context, the receiving/identifying step may be obtained using a touch pad having a surface which may be engaged by the user along a closed curve. Alternatively, the receiving/identifying element may comprise a movable element, such as a rotatable element, part of which then performs the movement along the closed surface.

In this context, a closed curve may be any type of curve, such as a circle, an oval, a square, a triangle, a star, or any other curve.

Naturally, the receiving/identifying step may comprise determining or quantifying more than merely the movement. Also a direction of the movement (such as clockwise or counter-clockwise in relation to a point inside the closed curve), a velocity/acceleration or a position may be relevant. This is described in more detail below.

A contact may be a person, a group of persons, a company or the like. A number of manners exist of addressing a person or an entity. Groups of persons or entities may be defined in order to facilitate swift addressing of all members of the group. A group of that type would normally also be seen as a contact in addition to the individual members thereof. Any person or entity may be a part of any number of contacts in a list of contacts.

The information relating to contacts may be any type of information relevant to a person or an entity, such as a company. Thus, a name, a telephone number, an e-mail address, a physical address may be relevant, as may age, social security number, account details, or the like. Normally, when scrolling in an address book, the contacts are ordered after a predetermined characteristic, such as alphabetically after the given name or the first name.

In general, the present method and functionality may be available when, such as only when, the portable telephone is in an idle state, which means that the user does not use the telephone for other purposes, such as playing games, placing a call, viewing events or the like. The telephone may be in a state in which it is ready to receive incoming traffic but does not act on inputs of the user, before receiving the movement of the user.

In one embodiment,
the display/monitor is hardwired/configured or controlled by a processor receiving signals from the identifying/receiving element and being controlled, such as by software, to define a plurality of operations or states,
one of the operations/states is an idle operation/state where the processor, having received a signal from the receiving/identifying element, provides on the display/monitor the information relating to the one or more contacts,
the memory further comprises information relating to a plurality of events, and
in a predetermined operation/state different from the idle operation/state, the processor, having received a signal from the receiving/identifying element, provides on the display/monitor information relating to one or more of the events.

In this context, an event may be an image, a video, a video clip, a message, audio, such as music, or any other type of entertainment.

Thus, the same movement may be used in different operations/modes for scrolling in different types of information. This is natural in that it normally is desired to use the inputting devices of a telephone for as many different purposes as possible in order to reduce the overall number of input devices.

Changing between such operations/states/modes may be obtained when the method further comprises the step of the user inputting instructions by operating one or more input elements, the processor receiving pertaining information from the input elements and changes to a pertaining operation/state.

In another embodiment, upon detection/identification of further movement along the closed path, the processor may operate the display/monitor to scroll information relating to the contacts thereon. Thus, not only is the contact information provided on the display/monitor, but a scrolling between contacts (or in the information pertaining thereto) may be performed during the receiving/identification of the movement) such as to enable the selection of a contact.

In one situation, the processor, when a constant movement takes place along the closed curve, will scroll the information at a constant velocity (such as a constant number of information lines per unit of time). In this situation, a constant movement may be a movement with a constant velocity, whereby it may be desired that the receiving/identifying step also provides information relating to a velocity (along the curve or an angular velocity in relation to a predetermined position inside the closed curve) is also provided. Scrolling at a constant velocity may be obtained by providing information relating to a predetermined number of contacts-or a predetermined number of e.g. information items (lines, areas or the like representing predetermined information relating to a contact) per unit time.

In an especially interesting embodiment, the processor, when the movement along the closed curve is in a first, predetermined direction, controls the display/monitor to display the information relating to the contacts and, when the movement is along an opposite direction, controls the display/monitor to display other information from the memory. This may be when the processor is in the above idle state/operation/mode.

Thus, the direction of movement may be used for selecting the operation of the processor; in one direction, the contact information is provided, and in the other direction, other information is provided. This other information may be e.g. a keyboard or dial, if it is desired to enable a user to enter a telephone number one cipher at the time. Another type of information to be provided may be the latest called numbers or contacts. Alternatively, it may be desired to provide the user with calendar information or particular events, such as recently received (or un-read) messages (e-mails or SMS/MMS'es).

In a preferred embodiment, each contact or the information pertaining to the contact is characterized by one of a plurality characteristics, wherein the providing step comprises, during the receiving/identification of a movement along the closed curve, sequentially selecting a characteristic of the plurality of characteristics and providing information relating to contact(s) or pertaining information characterized by the selected characteristic.

In this respect, a scrolling is a sequential highlighting of information, where highlighting may be any manner of making one or more pieces of information stand out in respect of the other information provided. Thus, highlighting may be the altering of a font of the information, the colour, size, background or the like.

Normally, the contacts are ordered alphabetically, whereby the initial scrolling due to the receipt/identification of the movement, may then be between the letters according to which the contacts are ordered (first letter in the name, given name, first name, or any other manner logical to the user). During this scrolling, information relating to all or some of the contacts with the presently highlighted letter may be provided on the display/monitor. It may be desired to, during this scrolling, skip letters to which no contact information is pertaining.

In this embodiment, upon receipt of an instruction from the user, a characteristic is selected (typically the characteristic highlighted during the introduction of the instruction), and a received/identified movement brings about a scrolling between contact(s) or pertaining information characterized by the selected characteristic. Finally, a highlighted or selected contact may be selected and used for e.g. sending an SMS to, to call or the like.

Thus, having scrolled to the desired letter, the user will input an instruction, where after additional movement will bring about a scrolling in the contact information pertaining to the selected letter.

Naturally, the characteristic in which the first scrolling is performed need not be a letter but may be any characteristic, such as a personal relation (colleague, family, child, parent, friend, . . . ).

In general, the method may, naturally, further comprise the step of performing an action when a contact has been identified and selected, such as making a call to a telephone number of the contact, preparing or sending a message (e-mail, SMS, MMS or the like) to the contact, or the like.

A second aspect of the invention relates to a portable telephone comprising:
an element adapted to receive and/or identify a movement of a user or a part of the element along a closed curve, and for outputting a corresponding signal,
a display or monitor for providing information to the user,
a memory comprising information relating to one or more contacts,
a processor adapted to, upon receiving a signal from the receiving/identifying element, provide on the display/monitor information relating to one or more of the contacts.

As mentioned above, the receiving/identifying element may comprise a movable (such as rotatable) element or a touch pad having a surface engageable by a user in a closed curve. This element may be adapted to merely output a signal to the effect that a movement is sensed, or may output information relating to a velocity, position, acceleration, direction or the like relating to the movement detected.

In one embodiment:
the processor is hardwired/configured or controllable, such as by software, to define a plurality of operations or states,
one of the operations/states is an idle operation/state where the processor is adapted to, upon receiving a signal from the receiving/identifying element, provide on the display/monitor the information relating to the one or more contacts,
the memory further comprises information relating to a plurality of events, and
in a predetermined operation/state different from the idle operation/state, the processor is adapted to, upon receiving a signal from the receiving/identifying element, provide on the display/monitor information relating to one or more events.

This idle operation/state may be one in which the user does not use the telephone, were no information is requested by the user, such as playing games, calling another telephone, or viewing video/images or listening to audio. Thus, in this state, the telephone may be ready for receiving incoming traffic but may have its display turned of or dimmed.

Then, the telephone may comprise additional input elements for the user to input instructions, the processor being adapted to receive pertaining information from the input elements and change to a pertaining operation/state/mode.

Preferably, upon detection of further movement along the closed path, the processor is adapted to operate the display/monitor to scroll information relating to the contacts thereon and not merely provide information relating to e.g. a single contact.

In one embodiment, the processor is adapted to, upon detection/identification of a constant movement along the closed curve, control the display/monitor to scroll the information at a constant velocity.

In a preferred embodiment, the receiving/identifying element further is adapted to identify/determine a direction of the movement along the closed curve, and wherein the processor is adapted to have the display/monitor provide the contact information, if the identified/determined direction is a first predetermined direction, and other information from the memory, if the direction is a second, opposite, direction.

This determination of the direction may be easily facilitated when a touch pad is used. Alternatively, when a movable element is used, motion detectors may be used for determining the desired characteristics of the movement.

In a preferred embodiment, each contact or the information pertaining to the contact is characterized by one of a plurality characteristics, and wherein the processor is adapted to, while receiving the signal from the receiving/identification element, sequentially highlight a characteristic of the plurality of characteristics and control the display/monitor to providing information relating to contact(s) or pertaining information characterized by the highlighted characteristic. Finally, the contact may be selected for any desirable purpose.

Then, the telephone may further comprise an additional element for the user to enter instructions, the additional element being adapted to transmit an additional signal to the processor, the processor being adapted to, upon receipt of the additional signal, select a characteristic, where after, when receiving a further signal from the receiving/identifying element, the processor controls the display/monitor to display contact(s) or pertaining information characterized by the selected characteristic.

Naturally, in general, the telephone may also comprise standard means for performing a telephone call to a telephone number of a finally selected contact, or sending a message (SMS, e-mail, MMS or the like) to the contact on the basis of the pertaining information in the memory.

In the following, a preferred embodiment will be described with reference to the drawing, wherein:

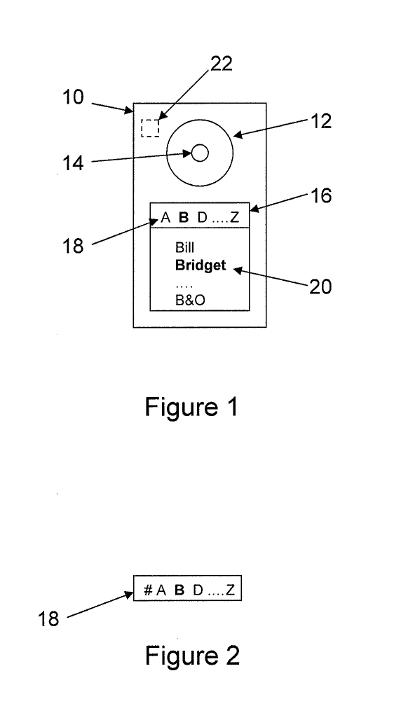

FIG. 1 illustrates a preferred embodiment of the invention and

FIG. 2 illustrates an alternative to the third area.

In FIG. 1, a mobile telephone 10 is illustrated having a user interface comprising a rotatable wheel 12 comprising a centrally positioned pressure sensitive button 14 as well as a display 16 suitably split up into two parts, an upper part 18 in which scrolling between starting letters of names in a telephone book are provided and a second, lower part 20 in which names having the selected first letter are selected between.

A processor indicated at 22 is adapted to receive signals from the wheel 12, button 14 and the display 16, if this is selected to be a touch screen, as well as to control the information provided on the display 16. Naturally, the display 16 may be made up of one or more displays if desired or required.

Operation of the present embodiment typically starts with the telephone 10 being in an idle state where no telephone call takes place. The telephone may not be used, or it may be used for another purpose, such as for playing music, playing games, viewing images/films/pictures, or the like.

Upon wishing to make a telephone call, the rotatable wheel 10 is rotated, whereby the display 16 is operated to illustrate the first letters or first initials, in a relevant alphabet, in the part 18, between which the user initially selects by scrolling to the first letter of the contact with which a telephone call is desired. The present selectable letter is highlighted in any suitable manner, such as by bolding as illustrated or by changing the letter or the background in any desired manner (changing size, colour, position on the display, or the like). When a letter is highlighted, the names (or other denotations of the contacts as selected by the user) having a first letter identical to the highlighted letter are provided in the area 20.

Naturally, if more names with that letter exist in the contacts database of the telephone, only a part of the names may be represented in the area 20. Alternatively, if fewer names exist with the relevant first letter than there is room for in the area 20, names from a next letter in the area 18 may be provided.

Rotation of the wheel 12 will endlessly scroll between the letters in the area 18, until a letter is selected by pressing the button 14, where after further rotation of the wheel 12 will scroll between the names in the area 20. An additional operation of the button 14 will call the actually highlighted contact.

Naturally, if, for one letter in the relevant alphabet, no contacts are available in the contacts list, this letter may be omitted in the list in the area 18. In FIG. 1, it is seen that no contacts with the first letter “C” are present, as “C” has been omitted in the list.

In one embodiment, rotation in any direction of the wheel 12 may bring about the above providing of the contacts and the scrolling in the first letters in the area 18. In this context, additional symbols or the like may be presented in the area 18 for providing other contacts or groups of contacts, such as is illustrated in FIG. 2, where a “#” is provided. Selecting this symbol will bring about a list of the most recently called numbers or contacts.

In another embodiment, only rotation in one direction (clockwise or counter-clockwise) may bring about the contacts, whereas rotation in the opposite direction may bring about another functionality, such as a list of recently called telephone numbers or contacts.

In general, it is desired that a constant rotation of the wheel 12 brings about a constant scrolling of the letters/symbols in the area 18 and/or a constant scrolling in the contacts provided in the area 20.

It is noted that the rotatable wheel may be replaced by a touch pad as may be seen on the Iphone® or the IPOD®, as may the button 14 or any additional information/instruction entering means desired for the above or additional functions of the telephone 10.

Naturally, it is understood that the telephone 10 may additionally comprise the elements usually present in mobile telephones, cell phones, and media players, such as one or more displays, touch sensitive areas, additional buttons, speakers, plugs for additional elements, such as ear phones, chargers and/or communication with external equipment, elements for wireless communication, antennae, vibration generating means, vibration sensing means, direction/position sensing means, storage capability, processor(s), or the like.

1. A method of operating a portable telephone, the method comprising:
receiving and/or identifying, using a receiving/identifying element, a movement of a user or an element along a closed curve,
receiving or providing, into a memory, information relating to one or more contacts, each contact or the information pertaining to the contact being characterized by one of a plurality characteristics,
upon receipt/identification of the movement, providing on a display/monitor information relating to one or more of the contacts,
characterized in that the providing step comprises, during the receiving/identification of a movement along the closed curve, sequentially selecting a characteristic of the plurality of characteristics and providing information relating to contact(s) or pertaining information characterized by the selected characteristic,
the method further comprising, upon receipt of an instruction from the user, a characteristic is selected, and a received/identified movement brings about a scrolling between contact(s) or pertaining information characterized by the selected characteristic.

2. A method according to claim 1, wherein
the display/monitor is controlled by a processor receiving signals from the identifying/receiving element and being controlled to define a plurality of operations or states,
one of the operations/states is an idle operation/state where the processor, having received a signal from the receiving/identifying element, provides on the display/monitor the information relating to the one or more contacts,
the memory further comprises information relating to a plurality of events, and
in a predetermined operation/state different from the idle operation/state, the processor, having received a signal from the receiving/identifying element, provides on the display/monitor information relating to one or more of the events.

3. A method according to claim 2, further comprising the step of the user inputting instructions by operating one or more input elements, the processor receiving pertaining information from the input elements and changes to a pertaining operation/state.

4. A method according to claim 1, wherein, upon detection/identification of further movement along the closed path, the processor operates the display/monitor to scroll information relating to the contacts thereon.

5. A method according to claim 1, wherein the processor, when a constant movement takes place along the closed curve, will scroll the information at a constant velocity.

6. A method according to claim 1, wherein the processor, when the movement along the closed curve is in a first, predetermined direction, controls the display/monitor to display the information relating to the contacts and, when the movement is along an opposite direction, controls the display/monitor to display other information from the memory.

7. A method according to claim 1, wherein the sequential selection of the providing step comprises omitting characteristics with which no contacts are available.

8. A method according to claim 1, wherein the sequential selection comprises also selecting, in a sequence of the characteristics, a symbol, the method further comprising selecting the symbol and providing to the user a list of most recently called numbers or contacts.

9. A portable telephone comprising:
an element adapted to receive and/or identify a movement of a user or a part of the element along a closed curve, and for outputting a corresponding signal,
a display or monitor for providing information to the user,
a memory comprising information relating to one or more contacts, each contact or the information pertaining to the contact is characterized by one of a plurality characteristics,
a processor adapted to, upon receiving a signal from the receiving/identifying element, provide on the display/monitor information relating to one or more of the contacts,
characterized in that the processor is adapted to, while receiving the signal from the receiving/identification element, sequentially select a characteristic of the plurality of characteristics and control the display/monitor to provide information relating to contact(s) or pertaining information characterized by the selected characteristic,
the telephone further comprising an additional element for the user to enter instructions, the additional element being adapted to transmit an additional signal to the processor, the processor being adapted to, upon receipt of the additional signal, select a characteristic, where after, when receiving a further signal from the receiving/identifying element, the processor controls the display/monitor to display contact(s) or pertaining information characterized by the selected characteristic.

10. A telephone according to claim 9, wherein
the processor is controllable to define a plurality of operations or states,
one of the operations/states is an idle operation/state where the processor is adapted to, upon receiving a signal from the receiving/identifying element, provide on the display/monitor the information relating to the one or more contacts,
the memory further comprises information relating to a plurality of events, and
in a predetermined operation/state different from the idle operation/state, the processor is adapted to, upon receiving a signal from the receiving/identifying element, provide on the display/monitor information relating to one or more events.

11. A telephone according to claim 10, further comprising additional input elements for the user to input instructions by operating one or more input elements, the processor being adapted to receive pertaining information from the input elements and change to a pertaining operation/state.

12. A telephone according to claim 9, wherein, upon detection of further movement along the closed path, the processor is adapted to operate the display/monitor to scroll information relating to the contacts thereon.

13. A telephone according to claim 12, wherein the processor is adapted to, upon detection/identification of a constant movement along the closed curve, control the display/monitor to scroll the information at a constant velocity.

14. A telephone according to claim 9, wherein the receiving/identifying element further is adapted to identify/determine a direction of the movement along the closed curve, and wherein the processor is adapted to have the display/monitor provide the contact information, if the identified/determined direction is a first predetermined direction, and other information from the memory, if the direction is a second, opposite, direction.

15. A telephone according to claim 9, wherein the processor is adapted to, during the sequential selection, omitting characteristics with which no contacts are available.

16. A telephone according to claim 9, wherein the processor is adapted to:
during the sequential selection, also select, in a sequence of the characteristics, a symbol,
upon selection of the symbol, control the display/monitor to display a list of most recently called numbers or contacts.
